(19) United States
(12) Patent Application Publication
(10) Pub. No.: US 2013/0262290 A1
(43) Pub. Date: Oct. 3, 2013

(54) METHOD AND SYSTEM TO AUTOMATICALLY GENERATE LOAN OFFER INFORMATION BASED UPON THE GEO-LOCATION OF AN END-USERS MOBILE COMPUTING DEVICE OR APPARATUS.

(71) Applicant: Alan Hanson, Garden City, NY (US)

(72) Inventor: Alan Hanson, Garden City, NY (US)

(21) Appl. No.: 13/435,354

(22) Filed: Mar. 30, 2012

(51) Int. Cl. G06Q 40/02; H04W 4/02

(52) U.S. Cl. 705/38

(57) ABSTRACT

The application relates to a method and system for using the location information of a potential property buyer's mobile apparatus for generating a lead or financing offer for a property or home being visited by a prospective buyer. The method involves an internet based system for collecting the buyers location information during the course of visiting potential properties, matching such location information with corresponding property specific information contained in a plurality of land or property records databases, automatically populating a plurality of finance lender's electronic applications or systems with such retrieved information, then further using such information to automatically compute, generate and transmit one or more qualified or non-qualified financing offers to the user, via the user's mobile computing device, other internet connected device, or additional means.

### A. CROSS REFERENCE TO RELATED APPLICATIONS: Not Applicable

### C. FEDERALLY SPONSORED RESEARCH: Not Applicable

### D. SEQUENCE LISTING OR PROGRAM: (Not Applicable)

### E. BACKGROUND—FIELD

This application relates to generating financing and mortgage offers.

### F. BACKGROUND—PRIOR ART

Previously, real estate financing offers were created based upon a combination of information provided by a potential buyer or borrower's and a lender or lenders' terms. The application improves upon the prior art to provide a system and method to automatically use a buyer's location information during a property visit and accessed via the internet and wireless communications, then further integrating that information with information automatically retrieved from land record database archives to create leads and mortgage offers significantly improving a lender's cost of loan acquisition.

### G. SUMMARY

### H. DRAWINGS—FIGURES

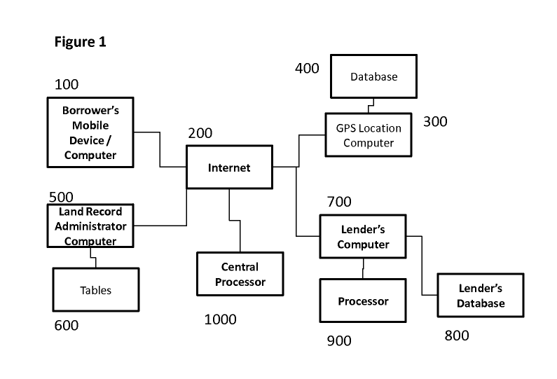

See FIGS. 1, 2, 3, 4, & 5 in file “GeoLoanOfferDrawings032812.pdf”

### J. DETAILED DESCRIPTION—FIRST EMBODIMENT—FIGS. 1, 2, 3 & 4

Broadly, the application is a method and system to automatically access and use a prospective asset purchaser's location information while visiting one or more prospective properties to generate a lead or financing offer. Such information is automatically accessed from a user's mobile device via a wireless network or internet means, and the information is further integrated with land record information retrieved automatically from a land record archive to create leads and mortgage offers improving a lender's cost of loan acquisition.

The application comprises a system for automatically collecting a user's (buyer/borrower's) location, or locations of a user's mobile device for the purposes of using such information in a process to generate a preliminary, or, where possible, an actual offer of potential financing using a multi-step process described hereinafter.

The applicant system comprises of a series of computers including mobile computing device or apparatuss are interconnected in a network as illustrated in FIG. 1. In this instance, a computer program controls a central processing system FIG. 1 1000 that orchestrates the flow of information collection, data retrieval and lead or offer management between a lender, or lenders' computers, and the additional computers in the network. Each of the parties is connected via a central interface hosted via the internet. The various computers identified in the network system are a user's mobile computing device or apparatus 100, a global positioning system computer 300, a land administration computer 500, and a lender's computer system, 700. The lender's computer system 700 will additionally have access a to plurality of databases 800 which may contain a variety of rules relating to the lender's loan programs to identify for example, whether the lender is approved to offer loans in the municipality in which the buyer/borrower's application is transmitting information about a particular property for purchase, what specific loan programs and offer's the lender may provide in such municipality, and specific rules relating to the lender's underwriting of potential loans in such municipality. Additional lender databases and third party databases may also be accessible to the network in order to access such information as a borrower/buyer's prior association with the lender's organization, or to verify the buyer/borrower's income. Such examples are illustrative only and not meant to represent an exhaustive list.

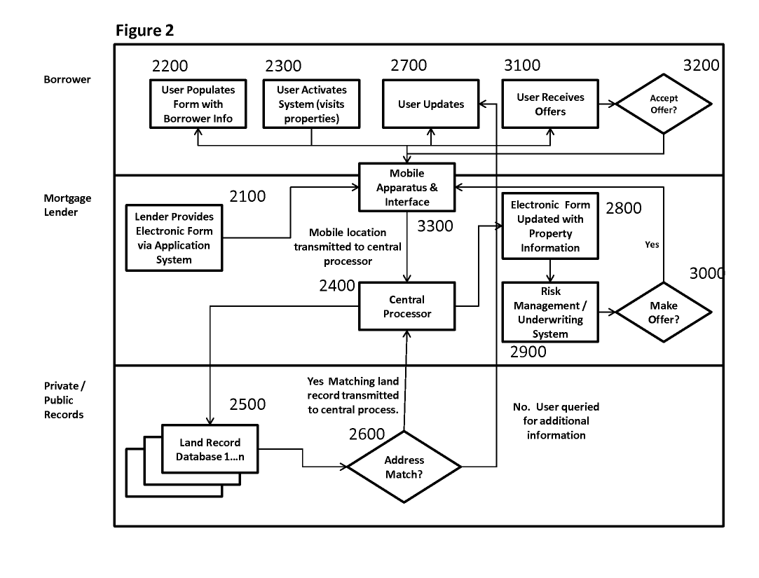

FIG. 2 illustrates an embodiment of the method for coordinating and carrying out the process between a user or prospective asset purchaser, a lending institution or institutions, and a land record administrator, whether such administrator is a public or private entity.

### K. OPERATION—FIRST EMBODIMENT—FIGS. 1, 2, 3, & 4

In FIG. 2 the mortgage lender or offerer provides the buyer/borrower with an electronic form via the internet that the user may access via the user's mobile device in step 2100. The borrower's information may be input into the system and stored upon system set-up step 2200, or alternatively, it may be captured at any time during use of the system, allowing that the advantage of capturing the buyer/borrower's information at the outset or application launch, will better enable the subsequent automatic generation of potential mortgage offers simultaneous with the time of any visit to a prospective property for purchase.

Broadly, the types of information provided by the buyer/borrower, irrespective of the sequencing in the process in which the buyer/borrower, comprise several categories including: borrower information (for example, a borrower's name, age, current address of residence and other personal identification information, a borrower's income, and a description of the borrower's assets); and financing information (for example, the intended amount that the borrower would be willing to pay and the amount, if any, that the buyer/borrower can self-finance. In the prior art, the potential borrower would need to provide one or more lenders not only with some number of these initial inputs in the form of loan financing application, but in addition the buyer/borrower would need to manually provide information, including the location, of the specific property for which financing is sought.

In step 2300, the buyer/borrower or user will activate or enable the system on the user's mobile computing device or apparatus to indicate when the buyer/borrower is visiting one or a more properties for purchase consideration. Upon such activation, the user's mobile computing device or apparatus will signal the start of the process of identifying the specific geo-location of the property being visited. The location identification process for determining the location of the specific device may be performed by any appropriate location identification system.

Thereafter, upon visiting one or more properties, step 2400, a user's location information is then transmitted from the mobile computing device or apparatus and automatically routed to a central processing system which seeks to ascertain a street address matching the device's specific location.

The processor reads the address information and compares the address information against a plurality of datasets containing land record information.

The system compares the zip-code level information to determine the most appropriate land-record dataset against which to search for a matching address.

In step 2500, upon finding a land-record dataset matching the specified zip-code information based upon the user's location, the system then performs a search to find a street name that matches the specific street name corresponding to that of the location of the user's mobile device. Such search may entail an iterative process to determine the street name that most closely matches the street name where such street names may have a variety of alternative forms in the zip-code data set (for example, Elm Street, Elm Road, Elm Avenue, etc. . . . )

Upon finding the street name information matching the user's location, the system then performs a search to find a specific property address (for example, the house number or other alpha-numeric designation) that matches the specific house number corresponding to the location of the user's mobile device.

Upon finding a matching address in the land record dataset inclusive of the house or property number, street name, town, city and zip-code information, the search shall be considered complete. In an alternate embodiment, however, the system shall also include additional functionality allowing the system to determine more specific address information as may be required to make an accurate match. Such instances may occur, for example, when the property comprises a multi-tenant structure. Such system functionality may comprise a variety of forms without limitation. These may include any or all of: a system prompt requiring the mobile buyer/borrower to manually input specific, additional floor-, apartment-, unit-, or suite-information; a system prompt requiring the user to select from a system-generated list of appropriate options to designate the additional floor-, apartment-, unit-, or suite-information; or an additional computation by the system to determine the specific user's exact location within the multi-tenant environment.

The comparison of the address being visited by the borrower/buyer against the addresses in the dataset will continue until, either an address is matched, or no address is matched in step 2600. In the event that the system cannot automatically determine an exact match with the mobile buyer/borrower's location, the system may prompt the user to input additional information in order to clarify, or better ascertain the user's exact address, or to better enable a match to the information in the land-record dataset, or to select an alternative land-record dataset against which to continue the address search as per FIG. 2 steps 2500 and 2600.

If the address corresponding to the user's mobile computing device or apparatus still does not match any of the addresses of a property contained in the datasets, the method will generate a null response.

The above mentioned system of address matching is provided as an example only and should not be limiting to the present application. Other sequences or methods for performing a search and match of addresses may also be employed.

Upon determining a match between a user's address and an address in the datasets, in step 2600 the system will retrieve from the dataset the land record information describing the specific property.

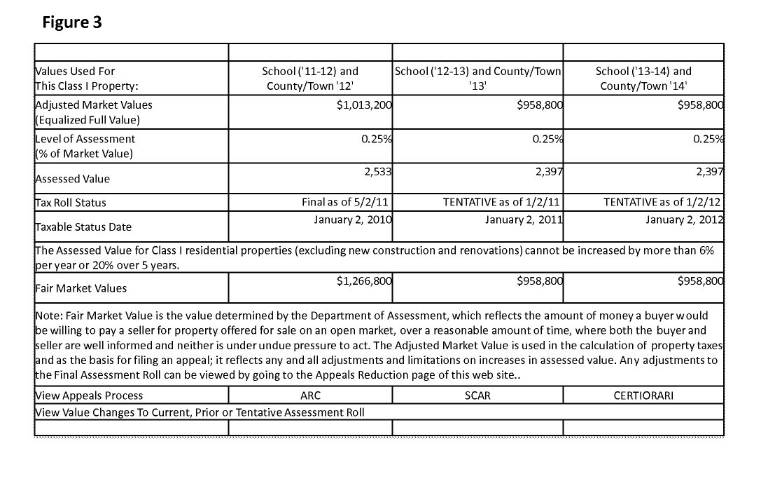

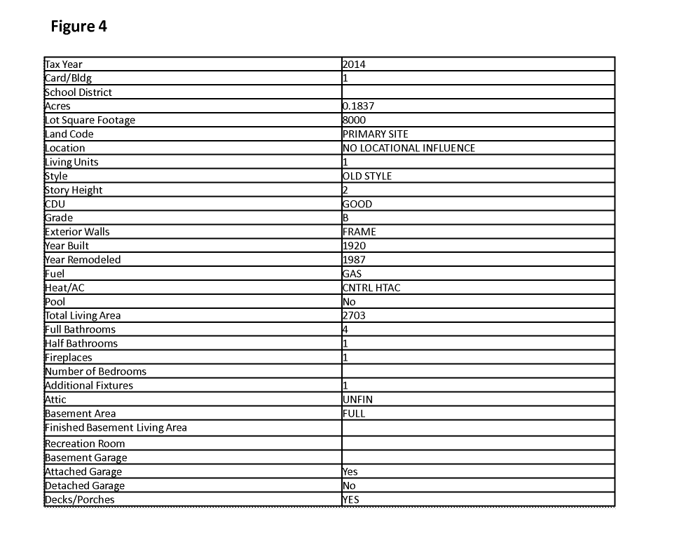

Such information may typically include attributes of the property and any of its dwellings, including, but not limited to the information illustrated in FIG. 3, including the Fair Market Value; the adjusted market value; assessed value; and tax roll basis of the given property for one or more years; and in FIG. 4, including the size of any dwelling(s) on the property; the date or dates of construction; dwelling type; the number and types of rooms; the last sale date of the property. Additionally, the land data records will include, but not be limited to information including, the annual taxes for the property; the lot number of the property; the property's size; the property's shape; its access points; the property's orientation (for example, north facing, corner plot, etc . . . ); and the floor-plan or layout of the property.

The reference representations of property information may be stored in several differing locations and within different types of datasets or systems, such as, but not limited to, locally on some non-volatile memory in a device, or in a centralized server. Communication between an object recognition system and a reference representation storage system may be utilized with different types of security levels and/or schemes and made accessible to the system by a person skilled in the art.

Such property information matching the location of the buyer/borrowers location is then transmitted to the central processing system. The electronic form inclusive of any borrower information that may have been previously captured is automatically updated with the property information retrieved from the corresponding record in FIG. 2. step 2800 for the purposes of enabling the generation of a customized financing offer. The information, including any drawings, schematics, or other property information is also automatically transmitted via the internet back to the buyer/borrower's mobile device for a variety of purposes including, but not limited to: allowing the borrower to affirm or authenticate that the property visually matches the property at which the borrower/buyer is located, providing the borrower with an additional means for evaluating the layout of the property under inspection (for example, an overhead floor-plan, or annual pre-sale property taxes for the subject property), or providing ready access to a variety of information that may be important to the buyer/borrower's purchase consideration of the property (alterations to the existing property, variances, actual property dimensions for comparison with a realtor's or setter's claims, tax information, etc . . . ). The lender's central processing system will input any or all of the retrieved land-record information, and any authentication thereof, into its system or systems to determine any or all of the following: appropriate market comparables between the retrieved land-record information and other previous sales of properties with similar characteristics; the estimated market value of the actual property or dwelling based upon any appropriate valuation or underwriting methods that the lending institution may prefer to rely upon for the purposes of making pre-qualified or qualified offers of finance; preliminary lists of property-specific conditions that may need to be addressed by the potential borrower for the purposes of securing financing.

Any or all of the property-specific information determined from the above process, including but not limited to the Fair Market Value of the property recorded in FIG. 3, is then combined with the borrower's information (again, by example only, a borrowers name, age, current street address, and other personal identification information, a borrower's income, and a description of the borrower's assets, and an indication of the borrower's intended down-payment, or self-financed, amount). After receiving such information in a loan application, a potential lender, through various means, will review the application for completeness, and may elect to verify various elements of the application such as the borrower's identity, income and credit-worthiness, and the value of the purchase property. Based upon its findings and its appetite for risk, the potential lender can elect to extend a qualified or unqualified offer of financing to the applicant borrower. A qualified offer may consist of any offer in which additional information or conditions must be met by the borrower, while an unqualified offer may require little or no other additional information or conditions that must be met. Such offers typically comprising a potential loan amount or range of such loan amounts, one or more rates of financing, one or more options for loan terms or duration, payment schedules, a description of any fees associated with administering or dosing the loan options, a period for which the loan offers would be valid, and additional provisions and conditions required to ultimately secure the loan.

Upon processing the property-specific, borrower-specific, and financing-specific information in accordance with the lender's risk-management, loan origination or underwriting system rules generating a market value, or market value range, for the intended purchase property is generated in FIG. 2 step 2900.

The lender may then compute an intended financing amount by subtracting from the market value or market value range for the specific property that has been used to auto-populate the loan application, the buyer/borrower's intended down-payment amount.

In FIG. 2 step 3000, the central processing system will then transmit to the buyer one or more potential mortgage offers, which may or may not include any qualifying terms, assumptions, or other conditions or disclosures. FIG. 2, step 1100, the user or borrower receives the loan offers transmitted bark to the user's mobile device. The buyer then has the option to ignore such loan offer, to store such loan offer, or to accept such loan offer by indicating his or her choice of options. In the event the offer is accepted, transmission of the offer acceptance back to the lender occurs via the network described in FIG. 1.

Throughout the process described in FIG. 2, because much of the information relayed between the participants may contain private information, except for the land information which is frequently available on a public land record database for inspection, the information will be encrypted. The information may be exchanged via a variety of means including secured webpage or Common Gateway Interface (CGI).

The applicant system and method in the first embodiment provides significant enhancement over the prior art, by allowing the mortgage offeror to automatically and dynamically compute information describing the user's location, and then via the internet and wireless communications, collect information specific to the exact property being visited by the potential buyer or user and present such users with a customized financing offer. Once an offer or offers are computed they can then be relayed back to a user's mobile device or other computer at the same time at which the buyer is visiting and evaluating the specific property and may desire, or in some cases need, to submit its purchase offer. This is particularly desirable in a competitive environment where one or more buyers may be bidding to purchase the same property.

The system and method have significant other advantages to the prior art. In the prior art, for example, in order to market a desire to make such real estate finance loans or offers to potential borrowers, and to respond to growing competition, potential lenders have marketed loan offers by providing potential buyers with a limited number of loan terms, for example the financing rate and loan term, (e.g., a 4.5% annual percentage rate, for a 30 year loan term) without first collecting any, or substantially any, information about the borrower, the financing required, or the intended purchase property or properties. Such offers range from simple advertising in various media, including print radio, television, and online, to more targeted forms of offer wherein some information about the borrower, the required amount of financing, or the property may be known. A number of these more targeted forms of offer are made over the internet. Commonly, for example, lenders would promote such forms of offer via an online banner or an ad placement, stimulated by a user performing certain activities online that may be indicative of the user seeking to purchase real estate for which they may need financing, for example, a search for “homes for sale in Tarrytown, N.Y.” This prior art method of generating offers of real estate financing presents disadvantages to the potential buyer/borrower, as well as to the potential lender.

For the potential lender, disadvantages of these prior art methods include the fact that potential competition for borrowers might be dependent on generic, un-customized offers, and its costs to reach potential customers is made higher because of this broad based approach; a search for “homes for sate in Tarrytown, N.Y.” is as likely be entered by a buyer/borrower, a home-seller, a real estate agent, or a local termite inspector; with only one of these parties representing the lender's intended target audience, the buyer/borrower.

For the potential buyer/borrower, disadvantages of these systems include the fact that only very generic, or sometimes misleading rates and loan requirements and conditions may be determined, because the potential lender has little or no specific information about the borrower, the intended loan amount or, critically, the intended specific property for purchase.

These problems were partially solved by the introduction of internet based sites designed to allow the user to perform real estate search and evaluation activities, including, but not limited to, conducting searches for potential properties that meet various criteria, and reviewing recent home sale prices. Additionally, some such sites also provide an application or “app” that can be downloaded to a user's mobile device in order to allow the user to perform these activities remotely from a larger internet access device. Although these applications or sites present certain improvements, they do not tend to significantly lower the lender's cost of reaching target buyer/borrowers, or reaching actual potential borrowers. The applications or sites, as one example, tend to attract large numbers of users who are drawn by their convenience in comparing real estate prices. For example, a present homeowner who wants to determine the present market value of his or her home, but who has no intention of selling that existing home, nor borrowing money to finance the purchase of a new home would nevertheless be likely to use such a site. As a result, this creates an overstated audience for the lender's advertisements and offers. Additionally, the present applications on mobile devices also do not make significant use of the user's present location to customize the offer to the specific location, or property, under consideration.

Typically, the user's location, if it is determined at all in the prior art, provides only limited additional value almost none of it to the mortgage offerer or lender. As one example, such user specific location information is used to allow banner ads to be targeted to a specific geographic location. As another example, they may provide the user with a visual display on a map in which the user's current location is graphically represented, and, depending on the user's selected preferences, the locations of homes for sale, recent sales prices, or other data in a radius surrounding the location are also depicted around such location. The application introduces a new method for using such information as the basis for significantly improving the offer process for mortgage lenders.

In order to market their desire to make such real estate finance loans and to respond to growing competition, potential lenders began to market loan offers by providing potential buyers with a limited number of loan terms, for example the financing rate and loan term, (e.g., a 4.5% annual percentage rate, for a 30 year loan term) without first collecting any or any substantial information about the borrower, the financing required, or the intended purchase property or properties. Such offers range from simple advertising in various media, including print, radio, television, and online, to more targeted forms of offer wherein some information about the borrower, the required amount of financing, or the property may be known. A number of these more targeted forms of offer are made over the internet.

### L. DESCRIPTION—ALTERNATIVE EMBODIMENTS—FIGS. 1, 2, and 5

In an alternate embodiment, the mobile computing device or apparatuss depicted in FIG. 1. 100 may be any of a number of various types of devices. These may include, by example only, any device including mobile telephones, tablet computers, laptop computers, or devices containing only unique tagging or tracking information, without specific computing capabilities, that provide the ability for a another computing program to track or compute the location of the user at a point in time.

In an alternate embodiment, the method may not require or rely on an electronic form as depicted in FIG. 2. 2200. Provision of the method may nevertheless not require the borrower to provide information about the borrower to an electronic form or for the property information to be loaded into such a form. The method may instead access borrower information through the indexing of the customer to a unique customer identification number, or indexed to the IP address(es) associated between the user and one or more mobile computing device or apparatuss or devices such as any of those described in the preceding paragraph. Similarly, unique property information may be accessed directly via the indexing of a unique property identification number into the processing systems.

In an alternate embodiment, the system and method may be used solely for the purposes of providing the financing offeror or lending institutions with a source of leads for follow up selling purposes, whether or not such leads are acted upon in a real time dynamic method to provide offers back to the users mobile devices as presented in the embodiments.

In an alternate embodiment, the system and method may be used to provide lease or rental financing in supplement to or instead of offers for purchase of specific properties.

In another alternate embodiment, the land record information or portions thereof accessed from computer FIG. 1. 500 and tables FIG. 1. 600, and described in FIG. 2. 2500 may be “pre-loaded” to a user's device such that access to the information is more readily available to the user and to the system upon a point of visiting one or more properties.

In an alternate embodiment, the Global Positioning System mapping computer FIG. 1. 300 and databases FIG. 1. 400 may be replaced by alternate mapping sources. By example only, there are various emerging mapping sources that use a variety of methods inducting land-based mapping and observation or crowd sourced or “Wiki” information either to supplement or replace mapping information from GPS sources. Such data gathering methods, regardless of their source-information processes, may be substituted into the system or method.

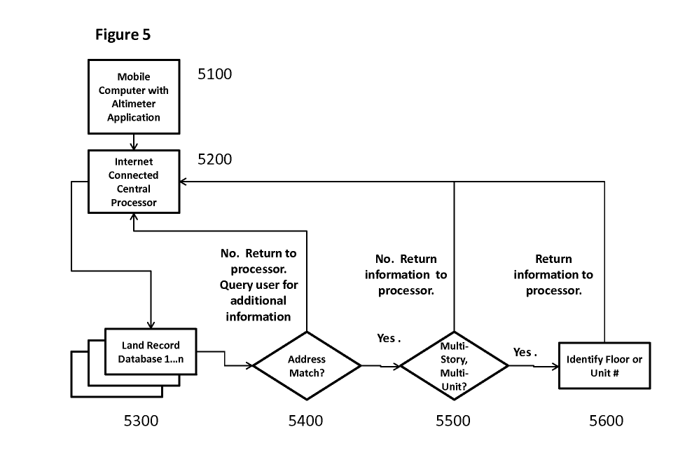

In an alternate embodiment, the information obtained from the mapping computer FIG. 1. 300 and databases FIG. 1. 400, or the address matching information obtained from the land record administrator's computers FIG. 1. 500 and data tables FIG. 1. 600 may be enhanced by additionally using altimeter information by placement of an additional application on the user's mobile computing device or apparatus FIG. 1. 100. By example only, commercially available mobile altimeter applications exist in the prior art. After downloading such an application to a user's mobile device, in addition to the mobile device's latitude and longitude coordinates being identifiable, the mobile device's distance from the ground, or its altitude, is also thereby identifiable. FIG. 5 depicts an example of the sub-process steps of this alternate embodiment. In FIG. 5. 5000 the user's mobile device, connected via the internet to the processor contains the additional altimeter application. This additional information is then attached to the electronic record that is used in querying the land record administrator's computer for an address match in 5400. If no property record or an inexact property record is found at the location matching the user's mobile address, then a query is returned to the processor and back to the mobile device user to ascertain additional information about the property being inspected. If instead, there is a match between the land records and the user's location at step 5500, then such an address is further reviewed under the systems rules to identify whether the mobile computing device or apparatus is located at the site of a multi-story, multi-unit building according to corresponding land records. If not, then the address information unenhanced to identify the property's story or floor information is returned to the processor for processing. If instead, at step 5500, the location of the mobile computing device or apparatus matches the address of a site containing of a multi-story, multi-unit building according to corresponding land records, then the additional distance-from-the-ground information matching the specific story of the building may then be processed to determine the floor, and in some cases, the unit at which the device is present. That information is then returned to the processing system for additional processing.

In an alternate embodiment, any of the information retrieved by the system's access to the land administrator's computer's and databases or tables supplying information thereto, including, but not limited to the data depicted in FIG. 3 and FIG. 4, may be used to compute for the system and method's various user's additional information, comparisons, analyses and reports for their use and evaluation in interacting with system and its users. For example purposes only, a lender may use prior year market valuation or trending market valuation such as that presented in FIG. 3 to determine its own valuation for the alternate purposes of determining whether the user represents a lead it wishes to pursue, or what level of valuation it places on the property in question for the purposes of making a loan. For example purposes only, a user or borrower, may use the property information such as that represented in FIG. 4, for the alternate purposes of determining whether to continue pursuing the purchase or lease of the considered property, or subsequent to the receipt of a financing offer, whether the valuation placed on the property by the lender comports to the user's view of property valuation for similar size and types of properties. Such examples are not meant to be limiting in their scopes.

In an alternate embodiment, the method in the application also may provide for the mortgage offeror to provide the borrower with multiple offers, rather than a single offer, based upon the range of variables input into the system. Such offers may include alternative financial propositions (for example only, offers assuming various amounts of down payment or pre-payment of fees), or the same financial proposition provided with alternative scenarios, such as periodic (i.e. monthly or bi-monthly) repayment amounts in order to allow the user to either evaluate, or select among the various offer(s).

In another embodiment, the method may allow multiple mortgage lenders competing on an ad-hoc basis, or in an online aggregated multi-mortgage finance application such as any of those that exist, to each make independent use of the system or the location-specific property information for the purposes of creating a customized set of offers. As a result, the method provides an improvement over the prior art, because such lenders can each more readily identify the specific property location, and do not need to independently retrieve land records, or rely upon the manual entry of information pertaining to a specific property, in considering what leads to pursue or what loan offers or terms to extend to the potential borrower using the additional information.

In another alternate embodiment, the system and method may allow for any number of analysis and reports may be auto generated by the system based on pre-populated rules coded in the central processor, in the lender's processor, or the mobile devices processor, and reported to the lender or the mobile user during or after the property visit, based on the information collected or stored at various points in the system. By example only, a program for the user a plurality of offers indexed to plurality of visited properties such that the various offers and properties may be analyzed and evaluated.

### N. CONCLUSIONS, RAMIFICATIONS, AND SCOPE

The application improves upon each of the prior art references. Although the description herein contains numerous specificities, these should not be construed as limiting the scope of the embodiments but as providing illustrations only of the preferred embodiments. For example, the method of user location identification may be achieved with the use of a system other than the Global Positioning System in order to ascertain the exact location of the user's mobile device.

I claim:

1. A method for automatically generating a loan offer based on the location of a users mobile apparatus, compromising:

2. Receiving an address corresponding to a location of an end-user's mobile apparatus based on its transmitted geo-location information, and comparing said address to a plurality of stored datasets containing property information indexed by address information to determine a matching address,

3. Retrieving the property information corresponding to the users mobile address,

4. Calculating an intended financing offer by evaluating the property information to determine market value and subtracting from the range of market values an intended or minimum down-payment amount, where the down payment amount is an amount that the borrower will provide toward the anticipated purchase,

5. Calculating a plurality of possible mortgage loan offers by means of inputting said intended financing amount into the mortgage loan offerer's risk management, loan origination, or underwriting models, or other such system,

6. Providing one or more loan offers to the end user's mobile apparatus.

7. The method of claim 1, further including a response button on the graphical user interface on the user's mobile device that allows the user to transmit acceptance of a mortgage offer to the lender or lenders.

8. The method of claim 1, further including the automatic population of retrieved land record information into a plurality of lenders' electronic application forms or systems.

9. The method of claim 1, further including leasing offers to be made based on the location of the user's mobile device.

10. A system for connecting a user's mobile computing devices or apparatus to location information systems, and to a plurality of mortgage lenders, and to land record administrators via the internet and wireless communications with means to generate location-specific leads or financing offers at a point of property inspection.

11. The system of claim 10, wherein said mobile computing devices or apparatus contains means for causing it to provide tracking information without computing ability.

12. A method for automatically generating a loan offer based on the location of a users mobile apparatus, compromising:

13. Receiving an address corresponding to a location of an end-user's mobile apparatus based on its transmitted geo-location information and the altitude information corresponding to the device's location, and comparing said address to a plurality of stored datasets containing property information indexed by address information to determine a matching address,

14. Retrieving the property information corresponding to the users mobile address and altitude,

15. Calculating an intended financing offer by evaluating the property information to determine market value and subtracting from the range of market values an intended or minimum down-payment amount, where the down payment amount is an amount that the borrower will provide toward the anticipated purchase,

16. Calculating a plurality of possible mortgage loan offers by means of inputting said intended financing amount into the mortgage on offerer's risk management, loan origination, or underwriting models, or other such system,

17. Providing one or more loan offers to the end user's mobile apparatus.
